(19) United States
(12) Patent Application Publication
(10) Pub. No.: US 2023/0398893 A1
(43) Pub. Date: Dec. 14, 2023

(54) APPARATUS AND METHOD FOR ELECTRIC VEHICLE CHARGING USING VIB ESS

(71) Applicant: STANDARD ENERGY INC., Daejeon (KR)

(72) Inventors: Bu Gi Kim, Daejeon (KR); Dong Young Lee, Daejeon (KR)

(73) Assignee: STANDARD ENERGY INC., Daejeon (KR)

(21) Appl. No.: 18/208,916

(22) Filed: Jun. 13, 2023

(30) Foreign Application Priority Data
Jun. 13, 2022 (KR) 10-2022-0071734
Aug. 26, 2022 (KR) 10-2022-0107295
Nov. 8, 2022 (KR) 10-2022-0147628
Jan. 31, 2023 (KR) 10-2023-0013341

(51) Int. Cl. B60L 53/62; B60L 53/53; B60L 53/10; H02J 7/00

(52) U.S. Cl. CPC B60L 53/62; B60L 53/53; B60L 53/11; H02J 7/0048; H02J 7/0063; H02J 7/00712; H02J 7/342

(57) ABSTRACT

Exemplary embodiments of the present disclosure provide a method and a system for electric vehicle charging, which receive power from at least one of the power grid and the energy storage system (ESS) and perform an electric vehicle charging procedure through the charger, receive the power of at least one of the power grid and the energy storage system (ESS) and perform the charging procedure through the charger, and are capable of charging the energy storage system (ESS) from the power grid or switching from discharging to charging of the energy storage system (ESS) during the electric vehicle charging procedure.

### CROSS-REFERENCE TO RELATED APPLICATIONS

This application claims the priority of Korean Patent Application Nos. 10-2022-0071734 filed on Jun. 13, 2022, 10-2022-0107295 filed on Aug. 26, 2022, 10-2022-0147628 filed on Nov. 8, 2022, and 10-2023-0013341 filed on Jan. 31, 2023, in the Korean Intellectual Property Office, the disclosures of which are incorporated herein by reference.

### BACKGROUND OF THE DISCLOSURE

### Technical Field

The present disclosure relates to an integrated system in which an energy storage system (ESS) and a charger are combined, and more particularly, to a system configuration and a control method for charging an electric vehicle (EV) by reflecting overall energy or a power supply situation of the integrated system.

### Background Art

An energy storage system (ESS) is a system that stores electricity in a battery or the like, and supplies power to a grid and/or other things that require power charging. Such energy storage system (ESS) can perform charging and discharging.

In recent years, as the use of an electric vehicle (EV) has increased, an EV charger is disposed and used in various locations. However, the use of the EV charger can increase or burden electricity consumption of the grid and influence other electricity usage in the corresponding location where the EV charger is installed. In particular, during times when electricity consumption is soaring, limitations on EV charger usage may be problematic.

Therefore, a method for stably performing charging in a location where the EV charger is disposed and providing a system therefor is required.

### SUMMARY OF THE DISCLOSURE

A feature to be achieved by the present disclosure is to provide a system for electric vehicle charging, in which an energy storage system (ESS) assists power charging via an EV charger to stabilize a power supply of a power grid and that can be driven by cooperating with such ESS power.

Another feature to be achieved by the present disclosure is to provide a power charging system in which the ESS can be simultaneously charged and/or discharged while charging an electric vehicle.

An additional feature to be achieved by the present disclosure is to provide a system in which a difference between a state of charge (SoC) of the ESS when electric vehicle charging starts and the SoC of the ESS after the electric vehicle charging ends is equal to or less than a predetermined value.

According to an aspect of the present disclosure, provided is a method for electric vehicle charging, which includes: receiving power from at least one of a power grid and an energy storage system (ESS) and performing an electric vehicle charging procedure through a charger; and receiving the power of at least one of the power grid and the energy storage system (ESS) and performing the charging procedure through the charger, and enabling charging the energy storage system (ESS) from the power grid or switching from discharging to charging of the energy storage system (ESS) during the electric vehicle charging procedure.

According to another aspect of the present disclosure, provided is a method for electric vehicle charging in an electric vehicle charging system in which the power grid connected to the energy storage system (ESS) has a maximum electric energy, and the charger connected to the energy storage system (ESS) and the power grid has a requested electric energy requested for charging the electric vehicle, which includes: a first step of charging the electric vehicle by discharging the energy storage system (ESS) for a power which is in a range of exceeding the maximum electric energy when the requested electric energy is equal to or larger than the maximum electric energy; and a second step of charging the energy storage system (ESS) with power in a range below the maximum electric energy when the requested electric energy is smaller than the maximum electric energy.

According to yet another aspect of the present disclosure, provided is a system for electric vehicle charging, which includes: at least one secondary battery capable of charging and discharging; an input unit receiving power from a power grid in order to charge the secondary battery; an output unit providing the power to a charger for charging an electric vehicle by discharging the secondary battery; and a control unit operatively connected to the secondary battery, the input unit, and the output unit and controlling a state of charge (SoC) of the secondary battery when the electric vehicle charging starts and a state of charge (SoC) of the secondary battery when the electric vehicle charging ends to be maintained to be similar to each other, in which the charging procedure is performed through the charger by receiving the power of at least one of the power grid and the energy storage system (ESS), and charging of the energy storage system (ESS) from the power grid or switching from discharging to charging of the energy storage system (ESS) is enabled during the electric vehicle charging procedure.

According to yet another aspect of the present disclosure, provided is a method for electric vehicle charging in an electric vehicle charging method that in an electric vehicle charging system in which the power grid connected to the energy storage system (ESS) has a maximum electric energy, and the charger connected to the energy storage system (ESS) and the power grid has a requested electric energy requested for charging the electric vehicle, which includes: a second step of charging the energy storage system (ESS) with power in a range below the maximum electric energy when the requested electric energy is smaller than the maximum electric energy, in which the charging procedure is performed through the charger by receiving the power of at least one of the power grid and the energy storage system (ESS), and charging of the energy storage system (ESS) from the power grid or switching from discharging to charging of the energy storage system (ESS) is enabled during the electric vehicle charging procedure.

When exemplary embodiments of the present disclosure are implemented, an energy storage system (ESS) may assist power use of a charger to stabilize power supply of a grid, and as a result, the charger may provide a more stable electric vehicle charging service when compared to that of the conventional art.

When one or more exemplary embodiments of the present disclosure are implemented, a charging system may be provided in which the ESS is simultaneously charged and discharged while charging an electric vehicle.

When one or more exemplary embodiments of the present disclosure are implemented, a system may be provided in which a difference between the SoC of the ESS when electric vehicle charging starts and the SoC of the ESS after the electric vehicle charging ends is less than or equal to a predetermined value.

The features of the present disclosure are not limited to the aforementioned features, and other objects, which are not mentioned above, will be understood by a person having ordinary skill in the art from the following description.

### BRIEF DESCRIPTION OF THE DRAWINGS

The above and other aspects, features and other characteristics of the present invention embodiments will be more clearly understood from the following detailed description taken in conjunction with the accompanying drawings, in which:

FIG. 1A is a conceptual diagram illustrating a power supply configuration with connection to a power grid, an energy storage system (ESS), and other electric devices according to an embodiment of the present disclosure;

FIG. 1B are graphical representations of outputs according to time at points A, B and C of FIG. 1A according to an embodiment of the present disclosure;

FIG. 1C is a conceptual configuration diagram of a system according to embodiments of the present disclosure;

FIGS. 2A, 2B, and 2C are graphical representations respectively illustrating a charger output, an ESS output, and a state of charge (SoC) of an ESS according to embodiments of the present disclosure;

FIG. 3A is a graph illustrating an output of ultra fast charging mode 1 for a charger 360 of a power supply system 300 according to additional embodiments of the present disclosure;

FIG. 3B is a conceptual diagram illustrating power providing in Phase 1 and Phase 2 of FIG. 3A;

FIG. 4A is a graph illustrating an output of ultra fast charging mode 2 for the charger 360 of the power supply system 300 according to additional embodiments of the present disclosure;

FIG. 4B is a conceptual diagram illustrating power providing in Phase 1 and Phase 2 of FIG. 4A;

FIG. 5 is a conceptual diagram illustrating a power supply configuration in which an energy storage system is disposed in a space and in which other electric devices are disposed according to an embodiment of the present disclosure;

FIG. 6 is a diagram illustrating a configuration in which the charger receives power from the energy storage system and a power distribution device according to an embodiment of the present disclosure;

FIG. 7 is a diagram illustrating a configuration of the energy storage system according to an embodiment of the present disclosure;

FIG. 8 is a flow chart illustrating a process in which a controller controls the energy storage system according to electric energy in a grid according to an embodiment of the present disclosure;

FIG. 9 is a conceptual diagram illustrating layouts and operations of the energy storage system and charger according to an embodiment of the present disclosure;

FIG. 10 is a conceptual diagram illustrating layouts and operations of the energy storage system and the charger according to another embodiment of the present disclosure;

FIG. 11 is a flow chart illustrating a process in which the energy storage system operates in response to a power use increase situation in the grid according to an embodiment of the present disclosure;

FIG. 12 is a diagram illustrating the configuration of the energy storage system according to another embodiment of the present disclosure;

FIG. 13 is a diagram illustrating a configuration of the charger according to an embodiment of the present disclosure.

FIG. 14 is a conceptual view exemplarily illustrating an operation state management range when a monitoring level is constituted by levels 1 to 4;

FIG. 15 is a conceptual view exemplarily illustrating a system according to an exemplary embodiment of the present disclosure; and

FIG. 16 is a conceptual diagram illustrating the charging/discharging of the ESS according to an exemplary embodiment of the present disclosure.

### DETAILED DESCRIPTION OF THE EMBODIMENT(S)

Various aspects and features of the present disclosure, and methods for accomplishing the same will be more clearly understood from exemplary embodiments described in detail below with reference to the accompanying drawings. However, the present disclosure is not limited to the exemplary embodiments set forth below and will be embodied in various forms. The present exemplary embodiments are just for rendering the disclosure of the present disclosure complete and are set forth to provide a better understanding of the scope of the invention to a person with ordinary skill in the technical field to which the present disclosure pertains, and the present disclosure can be defined by the scope of the claims. Throughout this specification, the same reference numerals denote the same elements.

Further, in describing the present disclosure, a detailed description of certain known related configurations and functions may have been omitted to avoid unnecessarily obscuring the subject matter of the present disclosure.

In describing the components of the present disclosure, terms including first, second, A, B, (a), (b), and the like may be used. These terms are just intended to distinguish the components from other components, and the terms do not limit the nature, sequence, order, number, or the like of the components, unless other specific wording that limits its meaning is used. When it is disclosed that any component is “connected”, “coupled”, or “linked” to other components, it should be understood that the component may be directly connected or linked to other components, but another component may be “interposed” between respective components, or the respective components may be “connected”, “coupled”, or “linked” via another component.

Hereinafter, in the present specification, features related to technology in which an energy storage system installed in a location such as a building or a house, a subway, a public space, etc., controls charging or discharging of the energy storage system according to an electricity use situation of other electric devices in the location will be described. Further, features related to technology in which the energy storage system controls a charger according to the electricity use situation will be described. In addition, features related to technology in which when power use loads of other electric devices in the space increase, the energy storage system supplies power to the other electric devices will be described.

In general, the energy storage system (ESS) is constituted by a battery, a battery management system (BMS), a power conversion unit, an energy management system (EMS), etc. The battery includes one or more cells, and a plurality of cells may constitute one module, and a plurality of modules may form one rack. The energy storage system (ESS) configured as such is connected to a power network, an electricity network, a power grid, etc., to receive the power.

The energy storage system (ESS) may be used in applying power for charging electric vehicle (EV). Here, there are states-of-charge (SoCs) in a battery in the energy storage system (ESS) and a battery within the electric vehicle (EV), respectively, and some related background technology thereof is described as below.

First, a charging/discharging rate (C-rate) of the battery should be appreciated. A charging rate of the battery and/or a discharging rate of the battery may be controlled by the charging/discharging rate (C-rate). The charging/discharging rate (C-rate) refers to a measurement of current used for charging and/or discharging the battery. As an example, charging a specific battery at 1 C-rate (or 1 C) can mean that a battery having a capacity of 10 Ah (i.e., an electric amount when current of 10 amperes (A) flows for 1 hour) may discharge 10 amperes (A) for 1 hour after the battery was completely charged. As such, the charging rate of the battery may also be represented by C-rate.

When a battery charged with a specific C-rate is measured, its state of charge (SoC) may be confirmed. Various controls for the charging may be performed by measuring the SoC of a battery in the energy storage system (ESS), by measuring the SoC of a battery in the electric vehicle (EV), and the like when charging an electric vehicle (EV) via the energy storage system (ESS).

Exemplary embodiments of the present disclosure to be described below relate to a system control used for charging the electric vehicle (EV) by using an integrated system having the charger of the electric vehicle (EV) being implemented with the energy storage system (ESS). The present inventors have devised a system control procedure by implementing certain features that are technically improved when compared to a conventional or existing system configuration and control method for a conventional energy storage system (ESS). The features of the present disclosure may also be expressed as an electric vehicle charging system that operates together with ESS power.

Hereinafter, the features of the present disclosure will be described in more detail with reference to the exemplary embodiments.

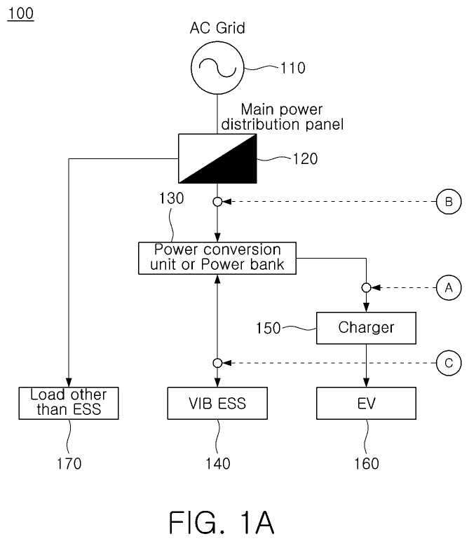

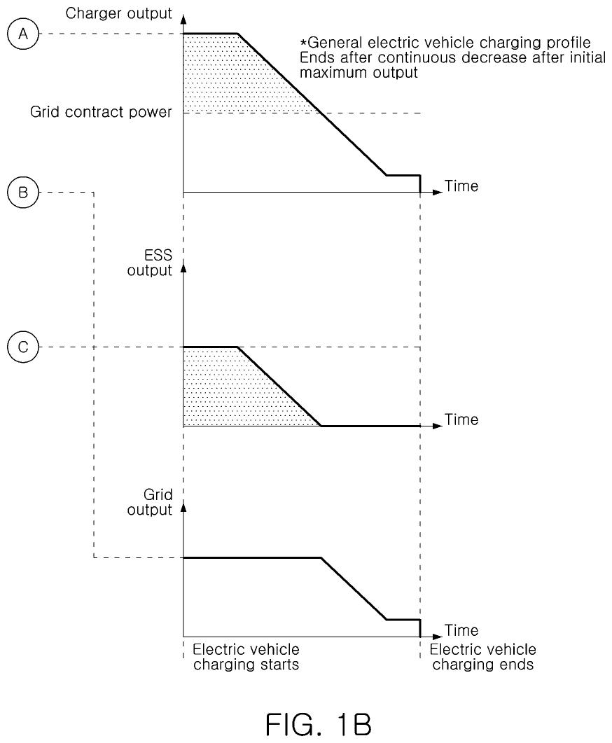

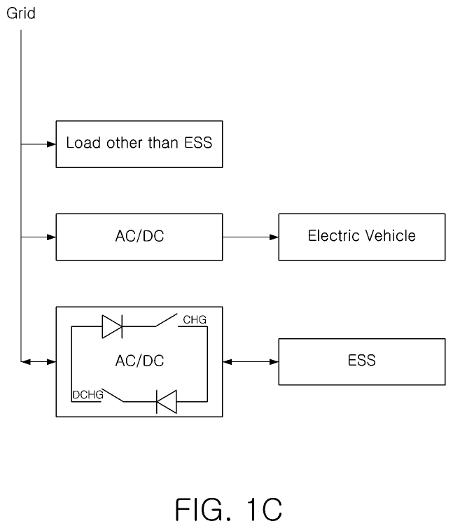

FIG. 1A illustrates a power supply configuration including a power grid 110, an energy storage system 140, and other electric devices 120, 130, 150, 160, and 170 in a power supply system 100 according to exemplary embodiments of the present disclosure.

In general, the power supply system 100 includes a main distribution panel 120 for receiving power, i.e., alternating current (AC) from the power grid 110, and the corresponding power is distributed and provided to the power conversion unit, a power bank, and/or similar power conversion equipment 130. Meanwhile, the main distribution panel 120 can also be connected to a load(s) 170 other than the ESS to supply power thereto.

The power conversion equipment 130 may be operatively connected to the energy storage system 140 such as a Vanadium Ion Battery (VIB) Energy Storage System (ESS) and provides a required control to transfer or receive power. Further, the power conversion equipment 130 may be connected to the charger 150, which may be connected to the electric vehicle (EV) 160 or other objects that require charging. The electric vehicle (EV) 160 may selectively receive at least one among the power provided by the power grid 110 and the power provided by the energy storage system 140 under the control of the power conversion equipment 130.

Here, at least one among the main distribution panel 120, the power conversion equipment 130, the energy storage system 140, the charger 150, the electric vehicle (EV) 160, and a load 170 other than the ESS may be installed within or adjacent to a particular location, e.g., a specific building.

The power supply system 100 can be installed and controlled to supply grid power to a specific building, and also additionally supply power for electric vehicle charging. Therefore, outputs for portions marked as A, B, and C in FIG. 1A will be described in more detail in FIG. 1B.

FIG. 1B shows graphical representations of outputs according to time points A, B and C of FIG. 1A.

FIGS. 1A and 1B illustrate the ESS and the charger in a combined configuration in which the ESS can assist in supplying power for EV charging and the ESS can be re-charged after EV charging ends, whereby overall power usage remains within a contract power of the power grid.

A graph of output A shows a charger output over time, and the electric vehicle is charged while receiving the power from the grid and the ESS. A maximum output is shown at a beginning phase and an initial phase of the electric vehicle charging and the charger output decreases over time. When nearing the termination of the electric vehicle charging, the output may reach its lowest level. The contract power related to the power grid is exemplarily expressed as a certain level, and hereinafter, the contract power will be described in more detail.

A graph of output B shows a grid output over time, and the maximum output is shown at the beginning phase and the initial phase of the electric vehicle charging. The output of the charger decreases over time and when nearing the termination of the electric vehicle charging, the output may reach its lowest level.

A graph of output C shows an ESS output over time, and the maximum output is shown at the beginning phase and the initial phase of the electric vehicle charging. The output of the charger decreases over time and when nearing the termination of the electric vehicle charging, the output may reach its lowest level. Here, the maximum output of the ESS is a value acquired by subtracting the contract power of the grid from the maximum output of the charger.

FIG. 1C is a conceptual configuration diagram of a system according to exemplary embodiments of the present disclosure.

The power from the power grid can be used for the electric vehicle charging and can be supplied to the EV charger after AC/DC conversion. To allow the energy storage system (ESS) to operates in assisting the grid for providing extra power, and to perform charging and discharging, a switching circuit can be implemented in an AC/DC conversion unit, such that a switching between discharging and charging of the energy storage system during an electric vehicle charging procedure can be performed.

Therefore, exemplary embodiments of the present disclosure may provide a method for electric vehicle charging, in which a charging procedure is performed through the EV charger by receiving power from at least one among the power grid and the energy storage system, and the discharging and charging operations of the energy storage system can be switched according to the state of the power grid during (and/or after) the electric vehicle charging procedure.

Subsequently, a relationship between the output of the EV charger, and the output of the ESS and its state-of-charge (SoC) will be described in more detail.

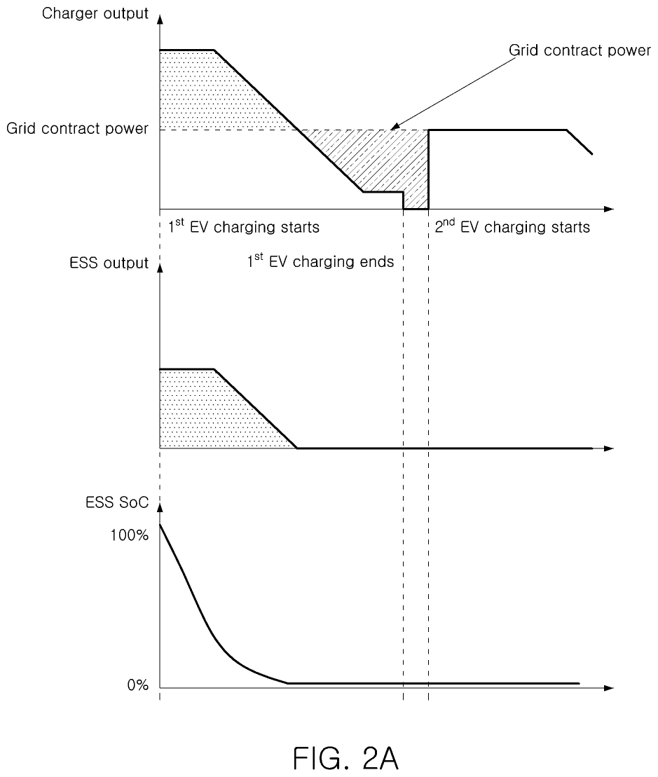

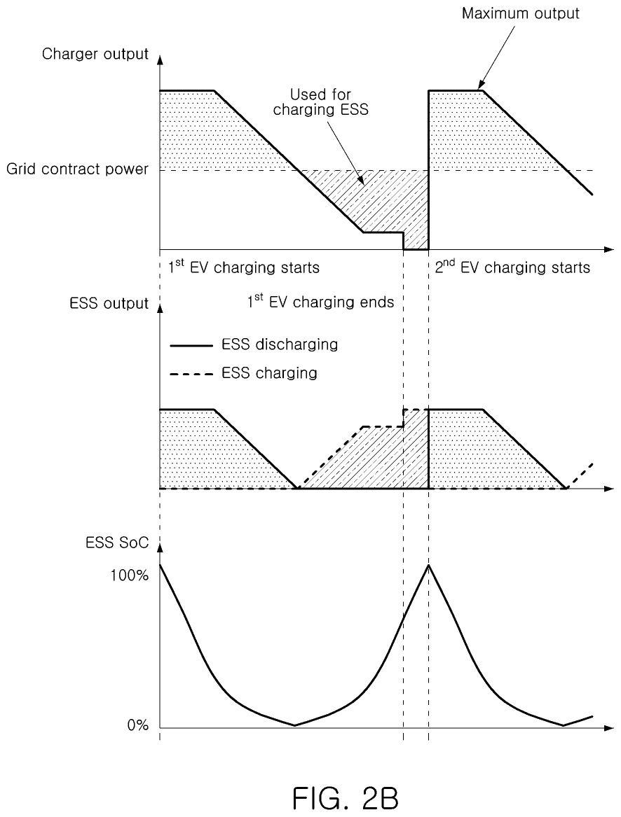

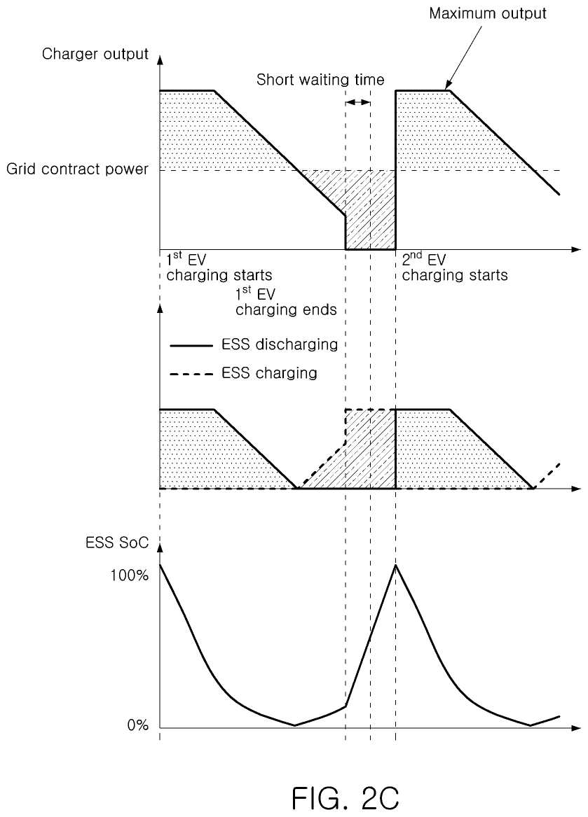

FIG. 2A is a conceptual diagram for the relationship between the output of the EV charger, the ESS output and its state-of-charge (SoC) according to a first exemplary embodiment of the present disclosure.

The description of FIGS. 1A and 1B pertain to a case where an output of the EV charger exceeds the contract power of the grid is required, for example, when starting the charging of a first electric vehicle (EV). The output of the EV charger decreases due to continuous discharging of the ESS over time and the power from the grid is used to perform charging, during a time interval that requires grid contract power or less, up to a charging termination time of the first EV. Thereafter, with respect to managing an EV charging station, it would be ideal if charging of a second (different) EV could be immediately performed after charging of the first EV is done, to thus accommodate as many electric vehicles (i.e., customers who pay for EV charging) as possible. However, in the conventional art, the charging of the second EV cannot be immediately performed, because the ESS has been completely or mostly discharged. That is, as can be seen from measurement of the SoC in the ESS, the SoC typically reaches a state of almost 0% at the first EV charging termination time.

When the EV charging is started in a state in which the ESS is fully charged, it is possible to charge the EV with maximum output from assistance through the ESS. When a capacity of the ESS is similar to the electric energy used in assisting a charging procedure for a first EV, it may be difficult to charge a second EV after charging of the first EV is completed. In order to solve this problem, an ESS of greater capacity may be provided, but doing so increases overall costs and profitability is lowered. As another method, the ESS may be charged again (i.e., recharged), but another EV cannot be charged during the conventional recharging time-period. Thus, EV charger profitability is not optimal, because EVs can only be charged one at a time using the conventional methods.

On the other hand, during the second half of a conventional charging procedure for a first EV, the inventors of the present disclosure recognized that there is a time interval during which the contract power of the grid is wasted. Based upon such problem recognition, a solution thereof has been conceived as described hereafter.

FIG. 2B is a conceptual diagram for a relationship between the output of the charger, and the output of the state-of-charge (SoC) of the ESS according to additional exemplary embodiments of the present disclosure.

With respect to some background technology, a lithium battery (LIB) currently used in many electric vehicles can be rapidly charged typically in low SoC conditions due to the particular electrochemical characteristics of the LIB. However, after repeated charging and/or discharging of the LIB, when the SoC increases to be greater than a predetermined level or more, the LIB is charged by lowering its charging speed for safety reasons, as LIB s are prone to overheating and/or fire risks. Even if a so-called super-fast charger for EVs is employed, such super-fast (or ultra-fast) charging can only be performed during an initial power charging time period and then a low-speed charging mode is used thereafter. In this regard, the present inventors recognized that an improved ESS that can assist the power grid should be able to supply optimal power according to an electric energy required for properly charging electric vehicles, and that vanadium-based batteries, such as a vanadium ion battery (VIB) having a wide charging and/or discharging (C-rate) coverage (or available range) is an optimal power supply means for an improved ESS.

Therefore, the present inventors have developed a charging system in which the ESS can be simultaneously charged and discharged during an electric vehicle charging procedure. That is, a system has been devised, in which ESS discharging is performed to supplement the power of the power grid during the electric vehicle high-speed (fast) charging interval, and then the ESS is charged according to the state of the power grid when entering the electric vehicle low-speed charging interval. Consequently, the system may be referred to as a scheme in which the difference between the SoC of the ESS when starting the electric vehicle charging and the SoC of the ESS after terminating the electric vehicle charging is less than or roughly equal to a predetermined value.

Further, the present inventors recognized that since changes in discharging output are relatively large according to the state of the power grid, employing vanadium ion batteries (VIBs) that have special electrochemical characteristics would be appropriate for implementation in an ESS, to allow handling of both low output and high output power charging procedures for improved EV charging.

The present inventors also propose that their inventive system be used for charging the VIB ESS by using the contract power of the grid that would be otherwise wasted, as can be understood from FIG. 2A.

Here, power charging may be performed with respect to at least one battery, at least one cell, at least one module, and/or at least one rack in the VIB ESS.

First, when the electric vehicle charging continuously occurs, if the charger output falls below a reference value, e.g., the contract power (of the power grid), a remaining surplus output may be used for charging the ESS. When a required control is applied according to the present embodiments, the SoC of the ESS remains relatively unchanged after the first EV charging is terminated to thus allow a second EV charging to be performed and completed. That is, the present inventors have devised a charging system in which both the charging and the discharging of the ESS are performed during an electric vehicle charging process, whereby grid power is supplied to a specific building (or other needed application) and also allows for electric vehicle charging such that an EV user may continuously use an EV charger without interruptions that occurred in the conventional art.

In the present embodiments, since a cycle of full charging and full discharging occurs in the ESS for each EV that is serviced, a VIB having a long lifespan is employed instead of other types of conventional batteries. Even though an EV charger is connected to an ESS having approximately half the capacity of a single electric vehicle, the EV charger could still be operated at maximum charging speed when using the scheme described via one or more embodiments described herein.

FIG. 2C is a conceptual diagram for another relationship between the output of the charger, and the output of the state-of-charge (SoC) of the ESS according to additional exemplary embodiments of the present disclosure.

Some EV users may simply decide to stop the EV charging process when the electric vehicle charging is undesirably interrupted or when the EV charging speed falls under a predetermined value. Therefore, there may be a need to establish a minimal charging time period for the ESS, and a maximum power charging output level may need to be controlled in order to secure such minimal charging time.

This is represented as a short waiting time in FIG. 2C, which shows a relationship between the charger output, the ESS output and the ESS SoC.

If the EV charging procedure is terminated before reaching a reference value used for switching from the discharging to the charging of the ESS, a control procedure for resuming super-fast charging may be performed after securing the charging time of the ESS for a predetermined time.

Alternatively, when the EV charging procedure is terminated and the super-fast charging is immediately conducted before reaching the reference value for switching from the discharging to the charging of the ESS, a control procedure for decreasing the super-fast charging power may be performed. For example, such control procedure may also be executed when it is difficult to discharge the ESS.

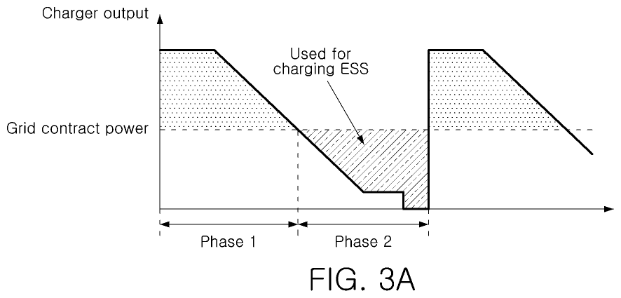

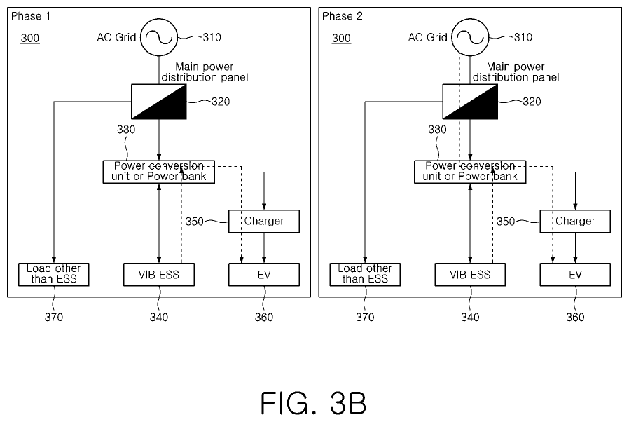

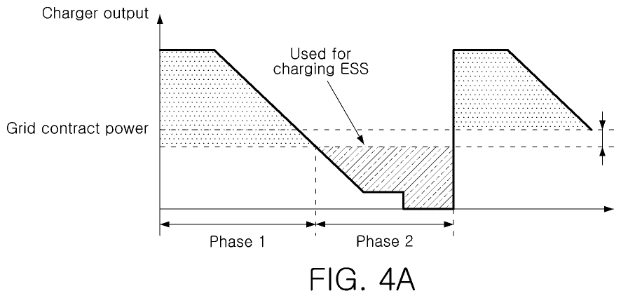

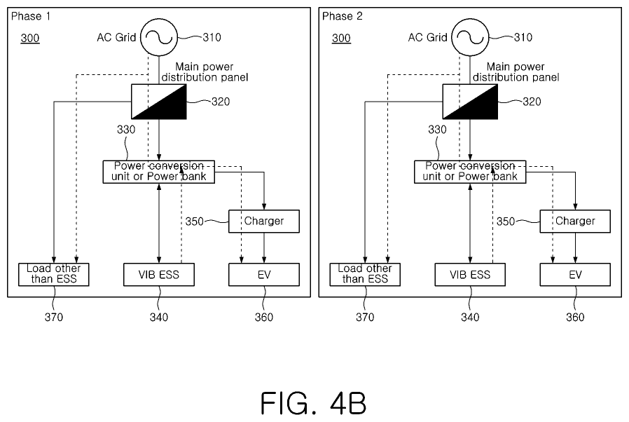

Next, the output of the charger according to additional exemplary embodiments of the present disclosure will be described in more detail with reference to FIGS. 3A, 3B, 4A and 4B.

FIG. 3A is a graph illustrating an output of super-fast charging mode 1 for a charger 360 of a power supply system 300 according to additional exemplary embodiments of the present disclosure.

Super-fast charging mode 1 is performed when the power need not be provided to loads other than the ESS. As a first step, the maximum electric energy, which may be used in the grid where the ESS is installed, is confirmed. In a second step, the EV charger's requested electric energy information is received. In a third step, comparison and determination are performed with respect to the electric energy in the first and second steps.

Here, surveillance or monitoring means, devices, sensors, measurers, instruments, power meters, etc., may be used for confirmation, comparison, and determination of various electric energies. Also, wired communication or wireless communication equipment and technology such as Wi-Fi may be utilized for transmitting and receiving the electric energy information.

Lastly, when EV the charger's requested electric energy is equal to or larger than the grid electric energy, the ESS provides additional power supply using excess grid electric energy. Alternatively, when the EV charger's requested electric energy is lower than the grid electric energy, any power that falls below the grid electric energy is used for charging the ESS.

Meanwhile, an interval in which the output of the charger is equal to, or more than the contract power of the power grid may be referred to as Phase 1, and an interval in which the output of the charger is equal to or less than the contract power of the power grid may be referred to as Phase 2.

FIG. 3B is a conceptual diagram illustrating power being provided in Phase 1 and Phase 2 of FIG. 3A. Here, a portion marked with the dotted arrow represents the power providing direction.

For charging the electric vehicle (EV) 360, the main distribution panel 320 sends the power provided by the power grid 310 to the power conversion unit, power bank 330. In Phase 1, which is the interval where the output of the charger is more than the contract power of the power grid, the VIB ESS is discharged, and the EV is charged with the power via the power conversion equipment 330 and the charger 350. On the contrary, in Phase 2, which is the interval where the output of the charger is less than the contract power of the power grid, the surplus power of the power grid is not wasted (as in the conventional art), but is used for charging the VIB ESS, and the EV is charged with the power of the grid via the power conversion equipment 330 and the charger 350.

FIG. 4A is a graph illustrating an output of super fast charging mode 2 for the charger 360 of the power supply system 300 according to additional exemplary embodiments of the present disclosure.

Super fast charging mode 2 is performed when power needs to be provided to one or more loads other than the ESS. As a first step, the maximum electric energy, which may be used in the grid where the ESS is installed, is checked. In a second step, the charger's requested electric energy information is received. In a third step, requested electric energy information of the load(s) other than the ESS is received. In a fourth step, the electric energies of the first, second, and third steps are compared and determined.

Here, surveillance or monitoring means, devices, sensors, measurers, instruments, power meters, etc., may be used for confirmation, and comparison and determination of various electric energies, and wired communication or wireless communication equipment and technology such as Wi-Fi may be utilized for transmitting and receiving the electric energy information.

Last, when the sum of the charger's requested electric energy and the load other than the ESS is equal to or larger than the grid electric energy, a power amount that exceeds the grid electric energy is provided by the ESS. Alternatively, when the sum of the charger's requested electric energy and the load other than the ESS is smaller than the grid electric energy, a power amount that is less than the grid electric energy is used for charging the ESS.

Meanwhile, an interval in which the output of the charger is equal to or more than the contract power of the power grid and an interval in which the power is provided to the load(s) other than the ESS may be collectively referred to as Phase 1 and an interval in which the output of the charger is equal to or less than the contract power of the power grid may be referred to as Phase 2. Here, it can be seen that Phase 1 of FIG. 4A is longer than Phase 1 of FIG. 3A due to the load(s) other than the ESS, and it can be seen that Phase 2 of FIG. 4A is shorter than Phase 2 of FIG. 3A.

FIG. 4B is a conceptual view illustrating power providing in Phase 1 and Phase 2 of FIG. 4A. Here, a portion marked with the dotted arrow represents the power providing direction.

For providing the power to the load 370 other than the ESS, the main power distribution panel 320 provides a part of the power of the power grid 310. Additionally, for charging the electric vehicle (EV) 360, the main power distribution panel 320 sends the power provided by the power grid 310 to the power conversion unit, power bank 330. In Phase 1, which is the interval where the output of the charger is greater than the contract power of the power grid, the VIB ESS is discharged, and the EV is charged with the power via the power conversion equipment 330 and the charger 350. On the contrary, in Phase 2, which is the interval where the output of the charger is less than the contract power of the power grid, the surplus power of the power grid is not wasted (as in the conventional art), but is used for charging the VIB ESS, and the EV is charged with the power of the grid via the power conversion equipment 330 and the charger 350.

For reference, FIGS. 4A and 4B illustrate a case where the power supply system 300 is installed and operated at a place such as a commercial facility, a public place, a specific building, etc.

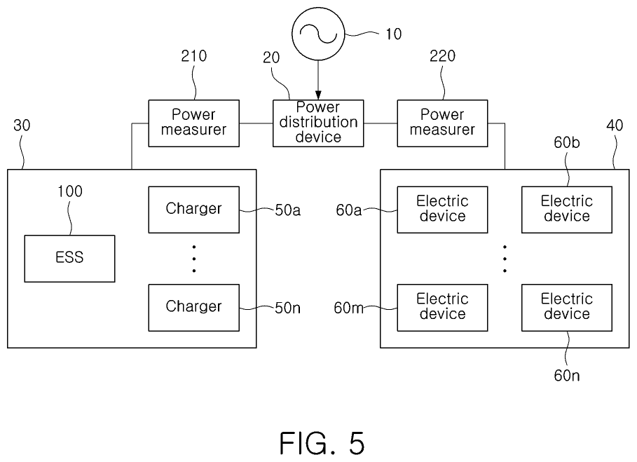

FIG. 5 is a diagram illustrating a configuration in which an energy storage system is disposed in a certain location and a configuration of power supply with other electric devices according to an exemplary embodiment of the present disclosure. FIG. 1 illustrates the energy storage system (ESS) 100 and other electric devices, and the grid corresponding to the power source 10 may supply power to a supportive power region 30 and a primary power region 40. The energy storage system (ESS) 100 may be disposed in the supportive power region 30.

The energy storage system (ESS) 100 and one or more chargers 50a to 50n may be disposed in the supportive power region 30. Multiple electric devices 60a to 60n may be disposed in the primary power region 40. Further, a separate ESS distinguished from the energy storage system 100 disposed in the supportive power region 30 may be disposed in the primary power region 40.

In the exemplary embodiment of FIG. 5, the power distribution device 20 may distribute the power to the supportive power region 30 and the primary power region 40. The energy storage system 100 may charge and/or discharge according to an electricity demand or an expected demand used in the two regions 30 and 40. To this end, a power measurer 210 may be connected to or disposed inside the supportive power region 30. Further, a power measurer 220 may be connected to or disposed inside the primary power region 40.

The power measurers 210 and 220, which are electric energy instruments (e.g., electric energy meters), measure electric energies which are used in regions where the power measurers 210 and 220 are installed. The power measurers 210 and 220 transmit such measured values (electric energies) to the energy storage system 100. Further, according to an exemplary embodiment of the present disclosure, a separate power measurer may also be disposed in the power source 10. In this case, the energy storage system 100 may confirm a magnitude of consumed power of the power source 10 in real time.

In this specification, the energy storage system includes an energy storage system including a vanadium ion battery, but the present disclosure is not limited thereto. For example, in this specification, the energy storage system may include a vanadium redox battery (VRB), a polysulfide bromide battery (PSB), zinc bromine battery (ZBB), and/or similar batteries.

When the exemplary embodiment of FIG. 5 is applied, if the charger 50 charges the electric vehicle or another device which needs to be charged, the charger 50 may perform charging according to a charging condition required by the electric vehicle or other devices. For example, when high-current charging is requested, the charger 50 performs the high-current charging. The power from the power source 10 and from the energy storage system 100 are provided to the charger 50 according to the control of the energy storage system 100. In addition, when the charger 50 performs low-current charging, the charger 50 is supplied with power from the power source 10 to charge the electric vehicle or other devices according to a power supply situation of the power source 10 or a power use situation of the primary power region 40 in the energy storage system 100.

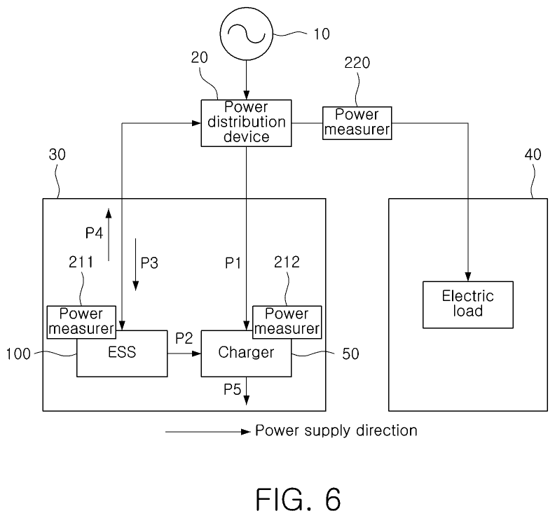

FIG. 6 is a diagram illustrating a configuration in which the charger receives power from the energy storage system 100 and a power distribution device 20 according to an exemplary embodiment of the present disclosure.

The charger 50 may be supplied with the power from the power distribution device 20 (P1) and/or power from the grid, i.e., from power source 10. In addition, the energy storage system 100 compares the information about the electric energies detected by the power measurers 211, 212, and 220 and the maximum electric energy that can be providable by the power source 10 to assist a part or the entirety of the electric energy needed by the charger 50.

The energy storage system 100 may supply the power to the charger 50 (P2). The charger 50 may switch or merge the supplied power according to the control of the energy storage system 100. The charger 50 may supply the power according to a charging request of an external device (P5).

The energy storage system 100 may be supplied with the power from the power distribution device 20 (P3). In addition, the energy storage system 100 may supply the power to the primary power region 40 (P4). The power supplied by the energy storage system 100 may be supplied to the primary power region 40 via the power distribution device 20. That is, a power supply direction between the energy storage system 100 and the power distribution device 20 may be bidirectional.

The power supply of the energy storage system 100 (P4) may be determined by the power demand of the primary power region 40, the maximum electric energy which may be provided by the power source 10, or by some other means.

When the energy storage system 100 supports fast charging and discharging functions of the charger 50, the energy storage system 100 monitors the electric energy of the grid 10 to flexibly respond to the power situation of the grid 10. In particular, the energy storage system 100 may predict a time period in which a power usage amount of the grid 10 is low based on accumulated or stored information for previous power usage amounts and times for the grid 10. As a result, the energy storage system 100 may anticipate and prepare for a case where power usage of the grid 10 is to be rapidly increased during fast charging and discharging processes of the charger 50.

Moreover, even when fast charging of the energy storage system 100 is required, the above anticipation process may be applied. That is, the energy storage system 100 may conduct the fast charging of the energy storage system 100 by being supplied with the power of the grid 10. Even in this process, it is possible to flexibly respond to the power situation of the grid 10 by monitoring the electric energy of the grid 10.

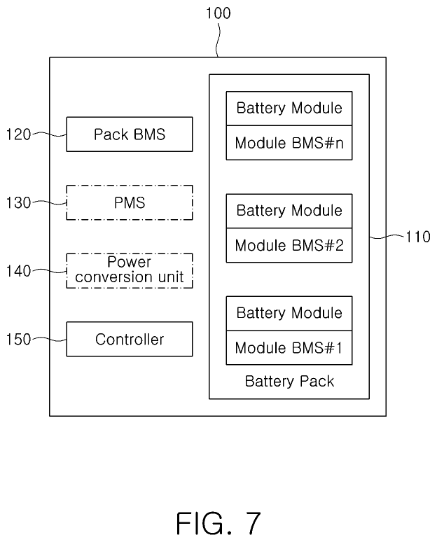

FIG. 7 is a diagram illustrating a configuration of the ESS according to an exemplary embodiment of the present disclosure. The energy storage system 100 includes an energy storage module 110 including a battery and a controller 150.

The energy storage system 100 may include a pack BMS 120 that manages charging and discharging of the energy storage module 110. Further, the energy storage system 100 may selectively include a power management system (PMS) 130 and a power conversion unit 140. When the energy storage system 100 includes both the PMS 130 and the power conversion unit 140, the energy storage system 100 may be referred to as an integrated ESS.

A module BMS manages the battery by monitoring a charging state, a discharging state, a temperature, a voltage, a current, etc., of the battery. The pack BMS 120 is a battery management system for an entire battery pack.

The controller 150 may determine charging and/or discharging of the energy storage module 110 by using a power measurement result of the supportive power region and the power measurement result of the primary power region or determine whether to discharge power to one or more chargers disposed in the supportive power region or the primary power region. Further, according to an exemplary embodiment, the controller 150 may be integrated with the PMS 130 to operate as one component.

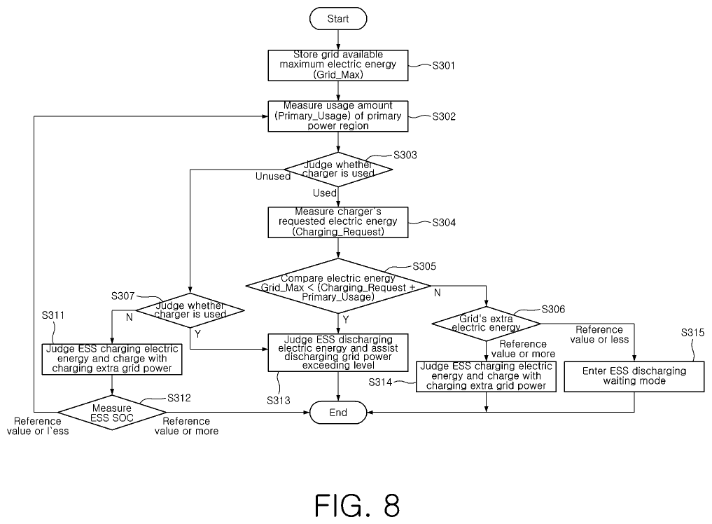

FIG. 8 is a diagram illustrating a process in which a controller controls the ESS according to electric energy in a grid according to an exemplary embodiment of the present disclosure.

The controller 150 may store information related to a maximum electric energy Grid_Max of the grid for supplying power to the primary power region and the supportive power region, i.e., power from the power source 10 (S301). The maximum electric energy Grid_Max means a maximum electric energy which may be used in the grid.

Thereafter, the power measurer 220 measures a power usage amount Primary_Usage of the primary power region 40 (S302). This is done by measuring the power usage amount (load usage amount) which is generated in a region other than the supportive power region 30 in which the energy storage system 100 is disposed.

Further, according to another exemplary embodiment of the present disclosure, in step S302, the energy storage system 100 or the controller 150 may receive a total power consumption of the grid and the power usage amount of the primary power region.

Next, the controller 150 determines whether the charger 50 disposed in the supportive power region 30 is used (S303). When there are multiple chargers 50, the controller 150 may determine which chargers 50 are used. If the charger 50 is not used, the controller 150 performs step S307. The controller 150 compares electric energies (S307), and compares Grid_Max and Primary_Usage, and when Grid_Max is equal to or larger than Primary_Usage, the controller 150 conducts charging by determining the ESS charging amount (S311).

In addition, the controller 150 measures a state of charge (SOC) of the ESS (S312) and may terminate charging when the SOC is equal to or more than an SOC reference value. Meanwhile, the controller 150 measures the SOC of the energy storage system 100 (S312) to control the charging of the ESS while repeating a process after step S302 again when the SOC is equal to or less than the SOC reference value.

Meanwhile, when Grid_Max is smaller than Primary_Usage in S307, the controller 150 determines a discharge electric energy of the energy storage system 100 to control the energy storage system 100 so that the energy storage system 100 discharges the power to the primary power region 40 (S313). As a result, an amount of power that exceeds the grid power is assisted (or supplemented) by the discharge of the energy storage system 100.

When the charger is being used in S303, the controller 150 measures a charger's requested electric energy Charging_Request (S304). In this case, it is assumed that the SOC of the ESS is equal to or more than the reference value. In addition, the controller 150 compares the electric energies (S305), and compares a sum (Charging_Request+Primary_Usage) of Charging_Request and Primary_Usage, and Grid_Max.

When Grid_Max is smaller than (Primary_Usage+Charging_Request) as a comparison result, the controller 150 determines the discharge electric energy of the energy storage system 100 to control the energy storage system 100 such that the energy storage system 100 discharges the power to the primary power region 40 (S313). As a result, an amount of power that exceeds the grid power exceeding level is assisted (or supplemented) by the discharge of the energy storage system 100.

Further, when Grid_Max is equal to or larger than (Primary_Usage+Charging_Request) as the comparison result of S305, the controller 150 confirms whether a difference (i.e., an extra electric energy of the grid, see Equation 1 below) is equal to or larger than a grid extra reference value (S306).

Extra electric energy of grid=Grid_Max−(Primary_Usage+Charging_Request) [Equation 1]

When the extra (or surplus) electric energy of the grid is equal to or larger than the grid extra reference value, the electric energy is sufficient, so the controller 150 determines a charging electric energy of the energy storage system 100 to control the energy storage system 100 so that the energy storage system 100 conducts charging (S314). This means that the energy storage system 100 conducts charging with the grid electric energy which is in surplus.

On the contrary, when the extra electric energy of the grid is less than the grid extra reference value, there is a high possibility that the power demands of the supportive power region 30 and the primary power region 40 will not be satisfied with the electric energy of the grid, so the controller 150 provides control to the energy storage system 100 to enter a discharge waiting mode (S315).

In FIG. 8, in the steps of charging the ESS (S311 and S314), the controller 150 may perform a high current charging process of the battery. In addition, the controller 150 continuously receives electric energy measurement results of the primary power region, and when the extra power of the grid decreases, the controller 150 may charge the battery with low current or control the ESS to enter the discharge waiting model as in step S315. Of course, even in the discharge waiting mode, the controller 150 monitors a total power situation of the grid and the SOC of the battery to determine whether low-power charging or high-current charging of the battery should be conducted.

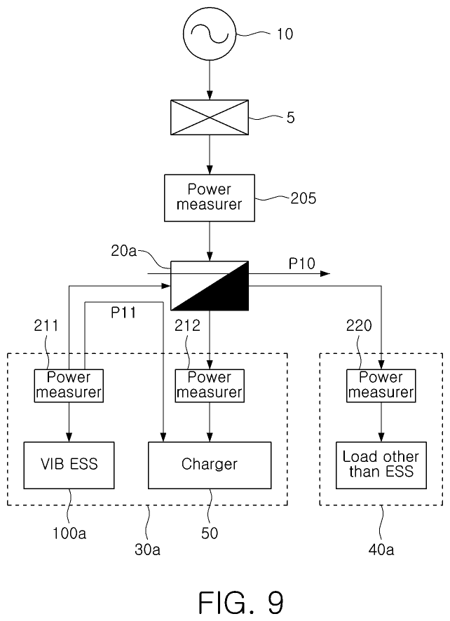

FIG. 9 is a diagram illustrating configurations and operations of the ESS and the charger according to an exemplary embodiment of the present disclosure. FIG. 8 illustrates a configuration in which a vanadium ion battery ESS (VIB ESS) 100a is disposed. An exemplary process of supplying electricity starts from the power source 10 as the grid, to a substation 5, to a power measurer 205, and to a power distribution device 20a which has the main power distribution panel as an exemplary embodiment. Then, the electricity is supplied from the power distribution device 20a to the VIB ESS 100a, to the charger, 50, and to the load(s) other than the ESS. The power measurer 205 may be disposed at or in the grid's main power line, and the power measurers 211, 212, and 220 may be disposed in respective regions 30a and 40a for each of the other power lines. Information about power consumption for each region and/or all regions can be sent to the VIB ESS 100a.

As described in FIG. 8 above, the VIB ESS 100a can store information on the maximum electric energy Grid_Max which may be used by the grid. Further, the VIB ESS 100a may receive information about a supply electric energy (e.g., an electric energy being used in reference numeral 40a) of the load other than the ESS from the power measurer 220 disposed in reference numeral 40a. Further, as an exemplary embodiment of the present disclosure, the VIB ESS 100a may receive the grid's total power consumption Grid_Usage from the power measurer 205.

As a power reception scheme, periodic reception and/or real-time reception are available. In the periodic reception, the corresponding period may be changed according to a change in electric energy used in the primary power region 40a. For example, the controller 150 may set the reception period to 5 minutes at night when the change in electric energy is not almost changed and set the reception period to 1 minute during the day when the change in electric energy is large.

The VIB ESS 100a may control charging and/or discharging of the VIB ESS 100a so as to optimize the power use of the grid according to the electric energy used in the primary power region 40a. A driving mode of the VIB ESS 100a may include a charging mode, a discharging mode, and a waiting mode. In the case of the charging mode, the VIB ESS 100a determines an ESS charging amount, and conducts charging according to the SOC reference value of the ESS and terminates the charging mode.

Further, the VIB ESS 100a may also assist (or supplement) some or the entirety of the electric energy output by the charger 50 (P11). For example, when a value (i.e., available electric energy) acquired by subtracting the power usage amount of the primary power region from the grid's maximum electric energy is smaller than the electric energy output by the charger 50 (namely, when there is a shortage level of the charging electric energy of the charger), the VIB ESS 100a may assist (or supplement) an amount of electric energy that matches the shortage level or an electric energy equal to or more than the shortage level. In the discharging mode, the VIB ESS 100a may receive information about the grid's total power consumption from the power measurer 205.

Further, when Grid_Usage equals Grid_Max or if Grid_Usage is more than Grid_Max, resulting in the power of the grid being cut off, the VIB ESS 100a may discharge its charged electric energy to the primary power region 40a. For example, when the VIB ESS 100a discharges the electric energy to the power distribution device 20a as in P10, the power distribution device 20a may supply the power to the primary power region 40a.

Further, the VIB ESS 100a may also assist some or the entirety of the electric energy output by the charger 50 (P11). For example, when a value (i.e., available electric energy) acquired by subtracting the grid's total power consumption Grid_Usage from the grid's maximum electric energy is smaller than the electric energy output by the charger 50 (namely, there is a shortage in the charging electric energy of the charger), the VIB ESS 100a may assist (or supplement) an electric energy that matches the shortage level or an electric energy equal to or more than the shortage level.

When the exemplary embodiment of FIG. 9 is applied, the VIB ESS 100a may optimize the electric energy of the grid according to the power use situation in the grid. For example, the VIB ESS 100a assists (or supplements) the electric energy to minimize loss due to excessive power or peak power and suppress grid overload.

Accordingly, the controller 150 of the VIB ESS 100a may receive the electric energy measurement result of the primary power region, and then determine a charging scheme for high-current charging and/or for low-current charging of the battery. The electric energy of the primary power region is compared with the grid's total usage amount, and when the electric energy of the primary power region is equal to or less than a predetermined reference (e.g., 80% or less), the VIB ESS 100a may be rapidly charged through the high-current charging.

On the contrary, when the electric energy of the primary power region is compared with the grid's total usage amount, and when the electric energy of the primary power region is more than the predetermined reference (e.g., more than 80%), the VIB ESS 100a is continuously charged through the low-current charging to lower the entire load of the grid and assist the grid power.

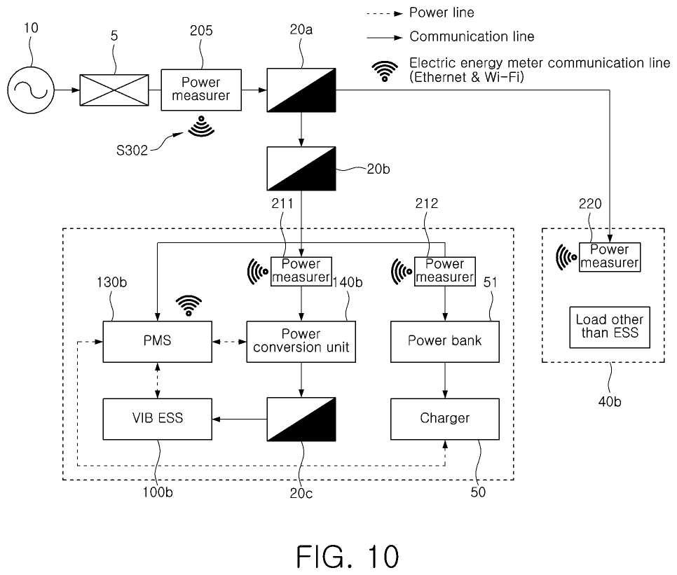

FIG. 10 is a diagram illustrating configurations and operations of the ESS and the charger according to another exemplary embodiment of the present disclosure. A configuration of FIG. 10 is an exemplary embodiment, unlike that of FIG. 9, in which a power distribution device 20a serving as the main power distribution panel and the power distribution device 20b serving as an ESS power distribution panel are distinguished. Moreover, the configuration of FIG. 10 shows a power distribution device 20c, serving as a DC power distribution panel (or container) for supplying the power to the VIB ESS 100b, that is separately disposed.

The power distribution device 20c may be configured to be divided into one or more components, but the present disclosure is not limited to a specific configuration scheme of the power distribution device. The power distribution device 20c may be selectively disposed according to the configuration, the layout, and the like of the VIB ESS 100b.

In FIG. 10, the PMS 130b and the power conversion unit 140b are separately represented, but the present disclosure is not limited thereto, as the PMS 130b and the power conversion unit 140b may also be configured together in the VIB ESS 100b. The PMS 130b can be integrated with the controller 150 to control the driving mode such as the charging and/or the discharging of the VIB ESS 100b.

Further, a power bank 51 may also be an integral component in the charger 50 according to an implementation scheme of the present disclosure or an independent component from the charger 50. In the configuration of FIG. 9, the VIB ESS 100a may assist (or supplement) the total power of the grid. The VIB ESS 100b stores information on a maximum output amount of the power grid. In addition, the VIB ESS 100b may receive the grid's total power consumption from the power measurer 205. Alternatively, the VIB ESS 100b receives a measurement value of a usage amount of the load other than the ESS to judge a grid usable electric energy. The VIB ESS 100b receives information on the grid's total power consumption or receives the measurement value of the usage amount of the load other than the ESS to control the charging or the discharging of the VIB ESS 100b.

The load other than the ESS indicates a load for power use other than the VIB ESS 100b and the charger 50, and means a load in the primary power region 40b such as power use in a building, and power use in a home, a server, a subway, etc.

The information on the grid's maximum electric energy may be input into the VIB ESS 100b in advance, and when the grid's maximum electric energy is changed, the VIB ESS 100b stores a changed value. The input value may be stored in the ESS 100b and maintained during a predetermined period. The VIB ESS 100b may store the information on the grid's maximum electric energy Grid_Max by a scheme such as 380 V AC/150 KW.

When the exemplary embodiment of FIG. 10 is applied, the grid such as the power source 10 supplies the power to the energy storage system 100b, to the charger 50, and to loads other than the energy storage system and the charger. Further, the energy storage system 100b may include one or more power measurers 205, 211, 212, and 220 that measure the electric energies of the grid, the energy storage system 100b, the charger 50, and loads other than the ESS.

In addition, the controller of the energy storage system 100b may determine the charging and/or discharging of the energy storage module by using the electric energy of the grid and/or the electric energies of other loads measured by the power measurers 205, 211, 212, and 220, or determine to supply the power to the charger or other loads.

In the case of an exemplary embodiment in which the electric energy of the grid may be confirmed by the electric energies of the loads other than the ESS, the energy storage system 100b may determine the charging and/or the discharging of the energy storage module by using the value measured by the power measurer 220 disposed in the load other than the ESS, or determine to supply the power to other loads.

Meanwhile, when the electric energy of the grid cannot be confirmed by the electric energies of other loads, or if it is necessary to confirm the electric energy of the grid in real time with minimal errors, the energy storage system 100b may determine the charging and/or discharging of the energy storage module by using the value measured by the power measurer 205 disposed in the power source 10, or determine to supply the power to the charger or other loads.

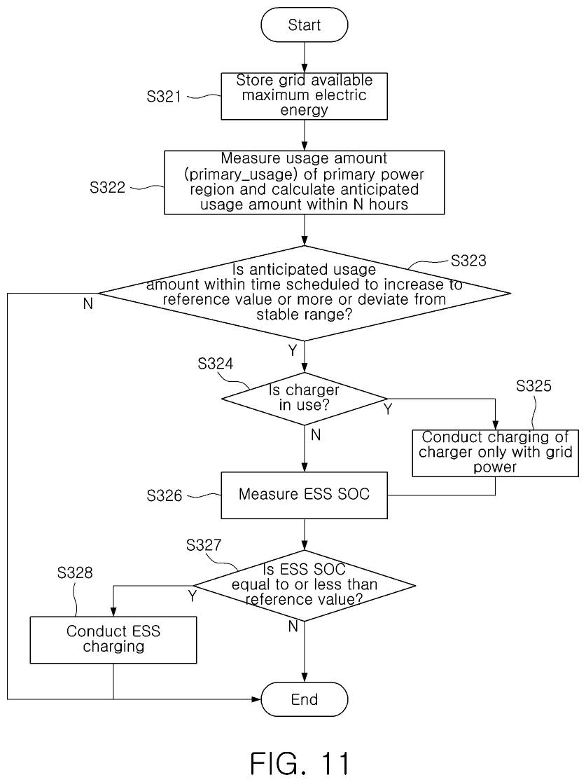

FIG. 11 is a diagram illustrating a process in which the ESS operates in response to an increased power usage situation in the grid according to an exemplary embodiment of the present disclosure.

The controller 150 stores the maximum electric energy Grid_Max that is usable by the grid (S321). In this case, the power source 10 may provide information about the maximum electric energy to the controller 150. Alternatively, the maximum electric energy of the power source 10 may be input into the controller 150 in advance.

Thereafter, the power measurer 220 measures a power usage amount Primary_Usage of the primary power region, and the controller 150 calculates an anticipated usage amount within N hours (S322). The controller 150 may accumulate and store information on the power usage amount Primary_Usage of the primary power region. The controller 150 monitors the power usage amount Primary_Usage of the primary power region in real time and calculates the anticipated usage amount within N hours of when the power usage amount increases.

In this case, the controller 150 may calculate the anticipated usage amount by reflecting seasonal factors. As an exemplary embodiment, the controller 150 may calculate the anticipated usage amount based on information (e.g., 2 p.m. to 4 p.m.) for a time zone in which an air conditioner is likely to be used in a corresponding space (the building, the home, etc.).

As a result, when the current power usage amount Primary_Usage of the primary power region belongs to a stable range or is equal to or less than a reference value, the controller 150 may determine whether the anticipated usage amount within N hours departs from the stable range or is more than the reference value (S323). In this case, the controller 150 may provide control to enter a waiting mode to assist the power usage amount Primary_Usage of the primary power region by preparing for an increase in power usage amount.

The controller 150 confirms whether the charger 50 is in use (S324). When the charger 50 is in use, the controller 150 may control the charging to be conducted only with the grid power (S325). This is to conserve the power charged in the energy storage system 100 so as to assist (or supplement) the power use of the primary power region.

Further, when the charger 50 is not in use or the charger 50 conducts charging only with the grid power, the controller 150 measures the SOC of the energy storage system 100 (S326). When the SOC of the energy storage system 100 is equal to or less than a reference value according to the measurement result (S327), the energy storage system 100 conducts charging (S328).

When the process of FIG. 11 is applied, if the power usage amount Primary_Usage of the primary power region increases, the energy storage system 100 may assist in the supply of power.

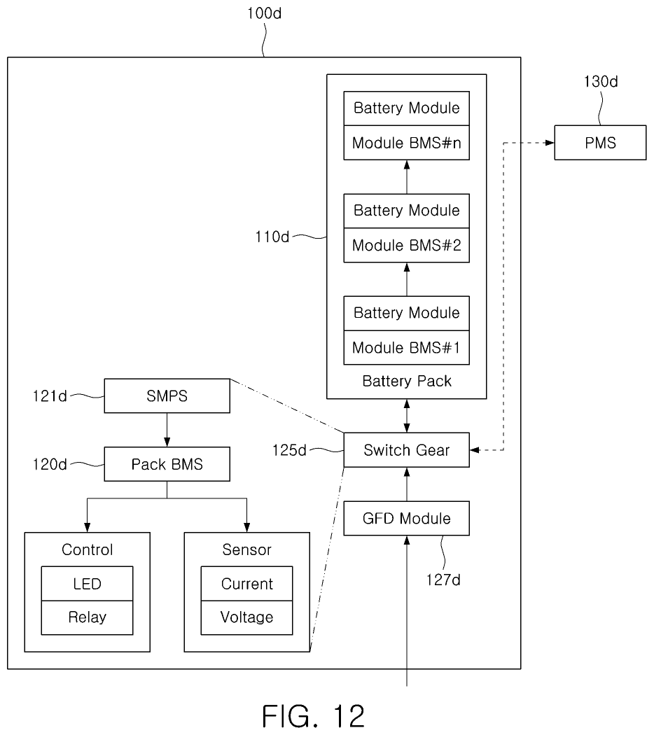

FIG. 12 is a diagram illustrating a configuration of the ESS according to another exemplary embodiment of the present disclosure. Power supplied from an external source is applied to a battery pack 110d via a ground fault device (GFD) 127d and a switch gear 125d. In the switch gear 125d, a switched-mode power supply (SMPS) 121d and a pack BMS 120d are used as an exemplary embodiment. The pack BMS 120d may provide control and sensing, control an LED and a relay, and sense current and voltage. In FIG. 12, the switch gear 125d and the PMS 130d may constitute the controller.

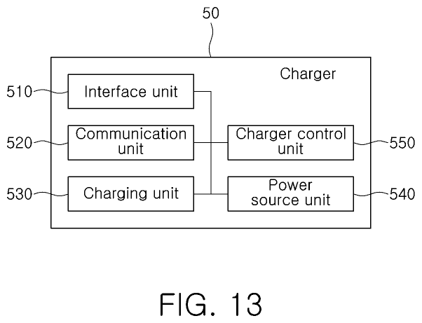

FIG. 13 is a diagram illustrating a configuration of the charger according to an exemplary embodiment of the present disclosure.

A charger control unit 550 controls an operation of the charger 50, and controls various components 510, 520, 530, and 540 constituting the charger 50.

An interface unit 510 provides an interface so that a user may input or confirm information in the process of charging various devices including the electric vehicle, an electric bicycle, etc., from the charger 50. The interface unit 510 may include a touch screen, buttons, and the like.

The communication unit 520 transmits and receives information to and from external devices. The communication unit 520 may receive from the ESS 100 or the PMS 130, information about a current available power situation, information on whether the input power is input from the grid or the ESS, and the like. Further, the communication unit 520 may transmit, to the ESS 100, the PMS 130, or the like, information related to a situation in which the charger 50 currently conducts charging. Alternatively, the communication unit 520 may transmit, to another charger, information related to a situation in which charging is currently being conducted.

A charging unit 530 can be used to charge various devices, such as electric vehicles, electric bicycles, electronic products, and the like. A power source unit 540 is supplied with the power from an external source and provides the power to the charging unit 530.

The charger control unit 550 outputs, to the interface unit 510, different types of information (such as price, time, options, etc.) related to the charging according to a source of the power supplied to the power source unit 540. The charger control unit 550 may control the charging unit 530 according to the source supplied to the power source unit 540, a charging option set by the interface unit 510, etc.

The charger control unit 550 determines a billing unit (based on a particular currency or monetary item) of a charged price or a charging time according to the type of supply source. The charging unit 530 conducts charging according to the time or price selected via the interface unit 510.

Some or all of the features of the present disclosure may be utilized in a battery charging management system in which a power usage history is analyzed and generated in a process whereby a user performs charging at an ESS facility or at an electric vehicle charging station to enable customer billing that matches an actually charged power amount and analyze a power use state and also confirm for any power loss. According to the exemplary embodiment(s) of the present disclosure, the battery charging management system described above may include a means for determining a use or consumption history for the power transmitted from the ESS and analyzing information on energy use and/or loss. A power use information analysis means may be used for solving problems due to abnormalities during power transmission from the ESS, which may cause differences between actual used power and transmitted power.

In order for an ESS operating system to conduct various controls so as to supply the power from the power grid to the battery of the ESS, various measurements, checks and/or monitoring of the inside of the battery, the outside of the battery, a surrounding environment, and an entire system should be performed for each step or level. According to at least one exemplary embodiment of the present disclosure, there may be 4 types of monitoring levels. Respective levels are connected by a network communication line or path, and serve to send and receive signals with each other, or issue or execute instructions and commands.

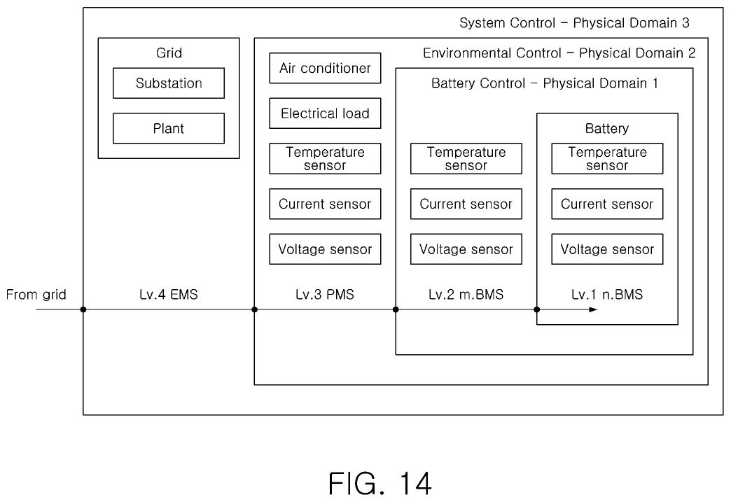

FIG. 14, as an example in which some or all of the features of the present disclosure are applied to an ESS security management system, is a conceptual view exemplarily illustrating an operation state management range when a monitoring scheme is constituted by levels 1 to 4.

According to at least one exemplary embodiment of the present disclosure, the monitoring scheme may include level 1 wherein the BMS is directly connected to the battery; level 2 that encompasses level 1 and has a master BMS for multiple BMSs in level 1 that are bundled and connected; level 3 that encompasses level 2 and has a power management system (PMS) in which at least one among cooling, heating, load control, and grid control is performed; and level 4 that encompasses level 3 and has a top-level energy management system (EMS) controlling at least one of the ESSs and the power systems in various regions. Exemplary details for a monitoring scheme having such four levels will be further explained below.

The battery charging management system of the ESS using four levels may include a power use information collection unit for collecting power use information related to actual charging power and other types of power (e.g., heater power, BMS balancing power, V2L power, external leakage loss power, etc.), an information analysis unit for distinguishing or analyzing the information collected by the power use information collection unit, and a charging execution unit to perform charging stop control or charging state control based on such an analysis result, and perform battery charging management.

Further, some or all of the features of the present disclosure may be used and applied to an electric energy supply method and a system thereof. More specifically, the present disclosure relates to an electric energy supply method that efficiently supplies power to an electric energy storage or electric energy consumption region including the energy storage system (ESS) through the power grid that is supplied with the electricity from the power supply source, and an electric energy supply device and an electric energy supply system using the same.

Further, in supplying the power from the grid and the ESS, information about power consumption and the remaining electric energy is collected and evaluated to efficiently control and manage the charging/discharging of the ESS or supplying of electric energy from the grid, so the electric energy of the grid may be optimized, loss due to excessive power or peak power may be minimized, and grid overload may be suppressed. Further, since a complementary relationship between the grid and the ESS may be maintained, a high output is available in spite of a shortage in the total supply of electric energy of the grid, a momentary power outage, and/or power cut-off, which results in system power being requested and supplied in a more stable manner.

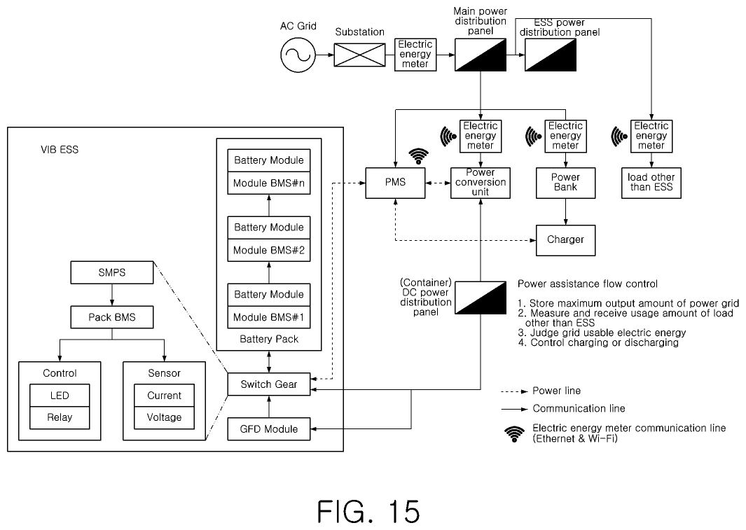

FIG. 15 exemplarily illustrates a system that supplies the power to the ESS and the power consumption region from the grid, controls information on consumable power obtained from the PMS of the ESS and power supplying to the power consumption region and performs electric energy supplying including ESS charging/discharging management.

There may be provided an electric energy supply system that includes an ESS that is supplied with the power through the grid and performs charging/discharging, a charger that is supplied with the power from a power source of at least one of the ESS or the grid, and an auxiliary facility that is supplied with the power of the load other than the ESS, and includes a step of storing maximum outputtable power outputtable from the grid; a step of measuring or receiving the use electric energy of the load other than the ESS of the auxiliary facility; a step of measuring the use electric energy of the grid; and a step of controlling the charging or discharging of the ESS based on the power information collected in each step.

It should be noted that an LIB (lithium-ion battery) emits heat and influences a battery lifespan upon high output, but a vanadium ion battery (VIB) is capable of more stable high output when compared to LIB s. Further, the LIB has a limit such as 1 C (i.e., 1 C-rate) charging and 1 C discharging, but the VIB is capable of input/output flow control at high output levels. For example, when a power outage of the grid occurs, the ESS using the VIB (i.e., a VIB ESS) is capable of assisting both the grid and the charger with the high output. In particular, for a VIB ESS, charging/discharging management thereof can be more efficiently performed when compared with other types of ESS technology. In particular, since there is no or minimal fire risk due to overload for VIB s, when the VIB is applied to the ESS according to the present disclosure, the ESS may be a very effective power supply system in that the electric energy supply system of the present disclosure may be applied under safe conditions for various facilities. Further, since it is possible to supply energy safely and efficiently, the embodiment(s) herein may be utilized as an energy supply means that is more effective, safe, and eco-friendly with respect to energy savings, environmental protection and achieving carbon neutrality.

Additionally, by utilizing some or all of the features of the present disclosure, a high C-rate output and cell balancing control according to such output may also be performed.

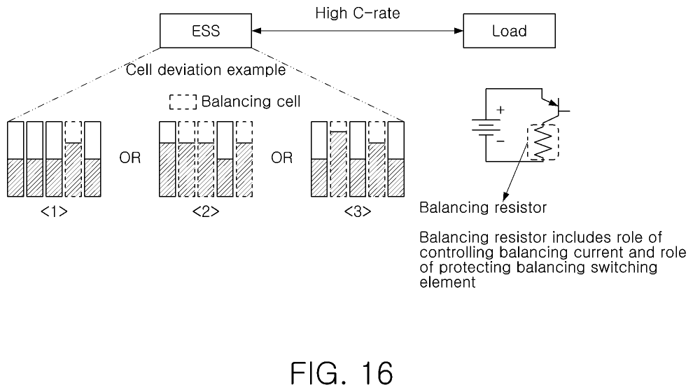

FIG. 16 is a conceptual view illustrating cases <1>, <2>, and <3> in which charging/discharging of the ESS is performed at high C-rate with respect to a specific load, and which exemplarily illustrate various cell deviations with respect to internal battery cells of the ESS.

The present inventors recognized that the probability of cell deviation occurrence and deviation voltages can increase upon high C-rate charging/discharging. To address such issues, a balancing current amount may be controlled by applying pulse width modulation (PWM), and the balancing current amount may be controlled by a scheme such as cell balancing with a maximum current amount at the high C-rate and/or cell balancing with a minimum current amount at a low C-rate.

In such manner, since the balancing current can be flexibly controlled, it is possible to stably maintain the high C-rate according to the embodiment(s) described herein. For example, when there are numerous cells in which cell deviations occur, the PWM may also be controlled so as to achieve more balancing with respect to a specific cell.

Various types of specific balancing schemes may be applied and it is fundamentally important to flexibly control the balancing current. Further, since a resistance value of a balancing current limiting element may protect a balancing switch element, the resistance value may be lowered by a maximum amount and the balancing current may also be controlled through current control through the PWM control.

Further, the present inventors also recognized that there may be a concern about stopping a cell monitoring BMS operation if too many cells are excessively discharged due to high c-rate charging/discharging.

When high-output discharge is performed when a conventional battery power source is used as in an existing configuration or in the related art, a stable operation is difficult to achieve due to input power variation of the BMS. That is, when the power supply of the BMS is interrupted, the ESS power is generally interrupted, causing many difficulties upon high-output discharge. To handle such BMS problems, an additional external power source could be used according to the related art, but additional parts and manufacturing processes are required, causing overall costs to increase.

To address such issues, the present inventors recognized that a boosting circuit may be configured and employed to allow the BMS to operate normally. If battery voltage is primarily input to the BMS, such input voltage can be boosted and provided as the BMS power input.

As a result, even when there are some deviations in the battery, the BMS can still operate in a stable manner. Also, even when there are multiple excessively discharged batteries, the BMS is enabled to stably operate. To achieve such results, since only a small number of elements can be added to an internal circuit board of the BMS, this exemplary embodiment of using an additional boosting circuit is cost effective and efficient.

The exemplary embodiments of the present disclosure may also be described as follows.

At least some exemplary embodiments provide an electric vehicle charging method that receives power from at least one of the power grid and the energy storage system (ESS) and performs an electric vehicle charging procedure through the charger, and is capable of charging the energy storage system (ESS) from the power grid or switching from discharging to charging of the energy storage system (ESS) during the electric vehicle charging procedure.

Here, in some features of the present disclosure, charging switching may be performed after ESS charging or discharging, but while charging the electric vehicle. This allows ESS charging to be performed simultaneously or jointly with the charging of the electric vehicle (EV), even if the EV is charged at a low speed. It should be noted that the charging speed of the electric vehicle can be performed at speed, high speed, ultra high speed, slow speed, rapid speed, etc., which may be determined differently according to many factors such as technical specifications, a capacity, an operation, commercial application, a battery type, charging/discharging technology, etc. of the electric vehicle charging system. For example, in some current electric vehicle charging systems, slow-speed charging is defined as charging being performed for approximately 10 hours or more and rapid-speed (or ultra-fast speed) charging is defined as charging being performed for approximately 1 hour. However, the features of the present disclosure are sufficiently applicable even to other systems having different charging speed values such as low-speed, high-speed, ultra high-speed, slow-speed, rapid-speed, etc., and are not limited to the exemplary charging speed names or values.

For some applications, the electric vehicle charging procedure enters a low-speed charging interval after a high-speed charging interval first starts, and the power of the power grid is primarily used in the high-speed charging interval to charge the electric vehicle. Also, the power grid may be assisted by performing the discharge of the energy storage system (ESS), and the charging of the energy storage system (ESS) can also be performed according to a state of the power grid in the low-speed charging interval.

Here, the high-speed or ultra-fast charging and the low-speed charging are concepts that are relative to each other and thus may also be variable according to certain factors, such as the power supply state of the power grid, the discharge situation of the ESS, and the like. The electric vehicle charging may be basically divided into three levels. Level 1 may be regarded as low-speed charging (e.g., of up to 16 A) made when a general outlet is used. Level 2 is charging using current of 32 A and is referred to as slow-speed charging (in Korea) when AC power is charged in the vehicle. Level 3 which supplies direct current of 400 V or more is referred to as rapid-speed or ultra-fast charging (in Korea). Therefore, in a first half portion of the electric vehicle charging procedure, high-speed (or rapid) charging is made via DC supply, whereby the power is relatively high and the speed is fast. In a second half portion of the electric vehicle charging procedure, low-speed (or slow) charging is made via AC supply, whereby the power is relatively low and the speed is slow. As another method, charging being performed at high speed or at low speed may also be defined and determined as a charging/discharging rate (i.e., C-rate) concept.

It should be noted that the state of the power grid is related to the contract power of the power grid, and an extra output of the power grid is used for charging the energy storage system (ESS).

Here, the contract power may mean a contract capacity promised to a power supplier, i.e., a power company. When the power company supplies electricity to a consumer, a supply condition (other than an electricity bill charged under electricity supply regulations) is determined. In other words, the contract power is related to a conversion of a customer's electricity usage into power, which an electricity supplier (e.g., Korea Electric Power Corporation) agrees to supply. The contract power can be used as a reference for calculating a basic facility fee that the customer pays to the electricity supplier as a result of electricity use. Such value can become a reference even when calculating a basic charge for a customer's electricity bill.

Meanwhile, the extra output is variable according to the state of the power grid. As one example, a surplus level of power requested in the system in which the ESS is installed may be regarded as an extra level. In this case, according to the present disclosure, specific control is executed so that a part or the entirety of the extra output of the power grid which is detected may be used for charging the ESS.

When the output of the charger decreases to a reference value or less, the energy storage system (ESS) is charged with the power provided by the power grid, and the reference value is related to the contract power of the power grid, and the extra output of the power grid is used for charging the energy storage system (ESS).

Since changes of the charging and discharging outputs of the energy storage system (ESS) are large according to the state of the power grid, a battery which may correspond to a range of the low output to the high output is applied to the energy storage system (ESS) to discharge or charge the energy storage system (ESS).

Here, the low output and the high output as concepts relative to each other may also be variable every that time according to the power supply state of the power grid, the discharge situation of the ESS, etc. As an example, in a first half of the electric vehicle charging, high-speed (rapid) charging is made by DC supplying in which the power is relatively high (i.e., high output), and in a second half, low-speed (slow) charging is made by AC supplying in which the power is relatively low (i.e., low output).

Provided is an electric vehicle charging method in which both charging and discharging of the energy storage system (ESS) are performed during the electric vehicle charging procedure.

Here, performing both the charging and the discharging may mean that the charging and the discharging are performed jointly. However, the performing of both the charging and the discharging does not mean that the charging and the discharging are particularly simultaneously performed. That is, the performing of both the charging and the discharging means that the ESS is discharged and the ESS is charged while the charging procedure of the electric vehicle is performed.

The discharging and the charging of the energy storage system (ESS) during the charging process are performed for a predetermined time so that a difference between the state of charge (SoC) of the energy storage system (ESS) when the electric vehicle charging starts and the state of charge (SoC) of the energy storage system (ESS) when the electric vehicle charging ends is adjusted to a predetermined level or less.

Here, the predetermined level of the state of charge (SoC) may also be regarded as a condition which is satisfied when the level at the charging start/end is included in a specific range. For example, it may also be regarded that a case where the states of charge (SoCs) at the charging start and end are within 20% with respect to each other is adjusted to a predetermined level or less. Depending on the management of the energy storage system (ESS), a corresponding range percentage (%) or a specific numerical value range may be variable.

The charging process enters a low-speed charging interval after a high-speed or ultra-fast charging interval first starts, and the power of the power grid is primarily used in the high-speed or ultra-fast charging interval to charge the electric vehicle, and the power grid is assisted by performing the discharge of the energy storage system (ESS), and the predetermined time is the low-speed charging interval.

Further, at least some exemplary embodiments provide an electric vehicle charging method that in an electric vehicle charging system in which the power grid connected to the energy storage system (ESS) has a maximum electric energy, and the charger connected to the energy storage system (ESS) and the power grid has a requested electric energy requested for charging the electric vehicle, includes a first step of charging the electric vehicle by discharging the energy storage system (ESS) for a power which is in a range of exceeding the maximum electric energy when the requested electric energy is equal to or larger than the maximum electric energy; and a second step of charging the energy storage system (ESS) with power in a range below the maximum electric energy when the requested electric energy is smaller than the maximum electric energy.

In the first step as the high-speed or ultra-fast charging interval, the electric vehicle is charged by primarily using the power of the power grid, and the energy storage system (ESS) assists the power grid, and in the second step as the low-speed charging interval, the charging and the discharging of the energy storage system (ESS) are performed according to the state of the power grid.

The electric vehicle charging method further includes a step of comparing the maximum electric energy and the requested electric energy in order to judge the state of the power grid.

The first step and the second step are performed to minimize the changes of the state of charge (SoC) of the energy storage system (ESS) when the electric vehicle charging starts and the state of charge (SoC) of the energy storage system (ESS) when electric vehicle charging ends.

Here, the minimization of the change of the state of charge (SoC) may also be regarded as a condition which is satisfied when a relative change amount at the charging start and end is included in a specific range. For example, it may also be regarded that a case where the states of charge (SoCs) at the charging start and end are within 10% with respect to each other is a state in which the change is minimized. Depending on the management of the energy storage system (ESS), a corresponding range percentage (%) or a specific numerical value range may be variable.

The state of charge (SoC) of the energy storage system (ESS) is periodically detected to perform charging up to a level of minimizing the change with respect to the energy storage system (ESS) when the electric vehicle charging ends.

Since the changes of the charging and discharging outputs of the energy storage system (ESS) are large according to the state of the power grid, the battery which may correspond to the range of the low output to the high output is applied to the energy storage system (ESS) to perform the first step and the second step.

The second step further includes a third step of charging the electric vehicle only with the power grid, and judging the state of the power grid while performing the second step to determine to charge the energy storage system (ESS). Namely, there is a third step that determines whether charging of the ESS is to be performed upon checking a state of the power grid while the second step is being performed.

Additionally, at least some exemplary embodiments provide an electric vehicle charging system that includes at least one secondary battery capable of charging and discharging; an input unit receiving power from a power grid in order to charge the secondary battery; an output unit providing the power to a charger for charging an electric vehicle by discharging the secondary battery; and a control unit operatively connected to the secondary battery, the input unit, and the output unit and controlling a state of charge (SoC) of the secondary battery when the electric vehicle charging starts and a state of charge (SoC) of the secondary battery when the electric vehicle charging ends to be maintained to be similar to each other, in which the charging procedure is performed through the charger by receiving the power of at least one of the power grid and the energy storage system (ESS), and charging of the energy storage system (ESS) from the power grid or switching from discharging to charging of the energy storage system (ESS) is enabled during the electric vehicle charging procedure.

Here, maintaining the states of charge (SoCs) to be similar may also be regarded as a condition which is satisfied when the relative level at the charging start/end is included in the specific range. For example, it may also be regarded that a case where the states of charge (SoCs) at the charging start and end are within 15% with respect to each other is a state in which the SoCs are maintained to be similar. Depending on the management of the energy storage system (ESS), the corresponding range percentage (%) or the specific numerical range may be variable.

The control unit provides a control for performing a first step of comparing the maximum electric energy of the power grid, and the requested electric energy requested for charging the electric vehicle in the charger connected to the energy storage system (ESS) including the secondary battery, and the power grid, and charging the electric vehicle by discharging the energy storage system (ESS) with respect to power in a range exceeding the maximum electric energy when the requested electric energy is equal to or larger than the maximum electric energy; and a second step of charging the energy storage system (ESS) with power in a range below the maximum electric energy when the requested electric energy is smaller than the maximum electric energy.

In the first step as the high-speed or ultra-fast charging interval, the electric vehicle is charged by primarily using the power of the power grid, and the energy storage system (ESS) assists the power grid, and in the second step as the low-speed charging interval, the control unit provides the control for performing both the charging and the discharging of the energy storage system (ESS) according to the state of the power grid.

The input unit, the output unit, and the control unit are provided to implement the energy storage system (ESS) with a secondary battery having a capacity smaller than a capacity of an energy storage system (ESS) adopting a lithium battery in the related art.

Here, the smaller capacity than the LIB in the related art may mean that a secondary battery having a smaller required capacity may be used so that the secondary battery shows a similar or equal performance under the assumption that other conditions are the same.

Since the changes of the charging and discharging outputs of the secondary battery are large according to the state of the power grid, a vanadium ion battery (VIB) capable of responding to both the low output and the high output is implemented as the secondary battery.

Further, additionally, the exemplary embodiment of the present disclosure provides an electric vehicle charging method that in an electric vehicle charging system in which the power grid connected to the energy storage system (ESS) has the maximum electric energy, and the charger connected to the energy storage system (ESS) and the power grid has the requested electric energy requested for charging the electric vehicle, includes a second step of charging the energy storage system (ESS) with power in a range below the maximum electric energy when the requested electric energy is smaller than the maximum electric energy, in which the charging procedure is performed through the charger by receiving the power of at least one of the power grid and the energy storage system (ESS), and charging of the energy storage system (ESS) from the power grid or switching from discharging to charging of the energy storage system (ESS) is enabled during the electric vehicle charging procedure.

The electric vehicle charging method further includes a first step of charging the electric vehicle by discharging the energy storage system (ESS) with respect to power in a range exceeding the maximum electric energy when the requested electric energy is equal to or larger than the maximum electric energy.

Even though it is described that all components constituting the exemplary embodiment of the present disclosure are combined into one or operate in combination with each other, the present disclosure is not particularly limited to the exemplary embodiment, and one or more of all components may be selectively combined and operated within a purpose scope of the present disclosure. Further, each of all components may be implemented as one independent hardware, but some or all of respective components are selectively combined to be implemented as a computer program having a program module performing some or all functions combined in one or a plurality of hardware. Codes and code segments constituting the computer program will be able to be easily inferred by those skilled in the art of the present disclosure. The computer program is stored in computer readable media, and read and executed by a computer to implement the exemplary embodiment of the present disclosure. The storage media of the computer program include a magnetic recording medium, an optical recording medium, and a storage medium including a semiconductor recording element. Further, the computer program for implementing the exemplary embodiment of the present disclosure includes a program module transmitted through an external device in real time.

It is to be understood that the above-described embodiments are to be considered in all respects as illustrative and not restrictive, the scope of the present disclosure being indicated by the appended claims rather than by the foregoing detailed description. In addition, it should be construed that all changes and modifications that are derived from the meanings and ranges of the claims and concepts equivalents thereto are included within the scope of the present disclosure.

What is claimed is:

1. A method for electric vehicle charging, the method comprising:
receiving power from at least one of a power grid and an energy storage system (ESS) and performing an electric vehicle charging procedure through a charger; and
performing the electric vehicle charging procedure through the charger using the power received from at least one among the power grid and the ESS, and enabling charging of the ESS from the power grid during the electric vehicle charging procedure or allowing switching from discharging to charging of the ESS during the electric vehicle charging procedure.

2. The method according to claim 1, wherein the electric vehicle charging procedure enters a low-speed charging interval after a high-speed or ultra-fast charging interval first starts, and the power of the power grid is primarily used in the high-speed or ultra-fast charging interval to charge the electric vehicle, and the power grid is assisted by performing the discharge of the ESS, and the charging of the ESS is performed according to a state of the power grid in the low-speed charging interval.

3. The method according to claim 2, wherein the state of the power grid is related to a contract power of the power grid, and an extra output of the power grid is used for charging the ESS.

4. The method according to claim 1, wherein, when an output of the charger decreases to a reference value or less, the ESS is charged with the power provided by the power grid, and
wherein the reference value is related to a contract power of the power grid, and an extra output of the power grid is used for charging the ESS.

5. The method according to claim 1, wherein, since changes of charging and discharging outputs of the ESS are relatively large according to a state of the power grid, a battery having a range coverage from a low output to a high output is applied to the ESS to discharge or charge the ESS.

6. The method according to claim 1, wherein both the charging and discharging of the ESS are performed during the electric vehicle charging procedure.

7. The method according to claim 1, wherein the discharging and the charging of the ESS during the charging process are performed for a predetermined time so that a difference between a state of charge (SoC) of the ESS when the electric vehicle charging starts and a state of charge (SoC) of the ESS when the electric vehicle charging ends is controlled to be within a predetermined level or less.

8. The method according to claim 7, wherein the charging process enters a low-speed charging interval after a high-speed or ultra-fast charging interval first starts, and the power of the power grid is primarily used in the high-speed or ultra-fast charging interval to charge the electric vehicle, and the power grid is assisted by performing the discharging of the ESS, and the predetermined time is the low-speed charging interval.

9. A method for electric vehicle charging that in an electric vehicle charging system in which a power grid connected to an energy storage system (ESS) has a maximum electric energy, and a charger connected to the ESS and the power grid has a requested electric energy requested for charging the electric vehicle, the method comprising:
a first step of charging the electric vehicle by discharging the ESS for a power which is in a range of exceeding the maximum electric energy when the requested electric energy is equal to or larger than the maximum electric energy; and
a second step of charging the ESS with power in a range below the maximum electric energy when the requested electric energy is smaller than the maximum electric energy.

10. The method according to claim 9, wherein, in the first step as a high-speed charging interval, the electric vehicle is charged by primarily using the power of the power grid, and the ESS assists the power grid, and in the second step as a low-speed charging interval, the charging and the discharging of the ESS are performed according to a state of the power grid.

11. The method according to claim 10, further comprising:
comparing the maximum electric energy and the requested electric energy in order to determine the state of the power grid.

12. The method according to claim 9, wherein the first step and the second step are performed to minimize changes of a state of charge (SoC) of the ESS when the electric vehicle charging starts and a state of charge (SoC) of the ESS when electric vehicle charging ends.

13. The method according to claim 12, wherein the SoC of the ESS is periodically detected to perform the charging up to a level of minimizing the change with respect to the ESS when the electric vehicle charging ends.

14. The method according to claim 9, wherein, since changes of charging and discharging outputs of the ESS are relatively large according to a state of the power grid, a battery, that is part of the ESS, capable of discharging power from a low output to a high output is used to perform the first step and the second step.

15. The method according to claim 9, wherein the second step further comprises charging the electric vehicle only with the power grid, and
wherein a third step determines whether to perform the charging of the ESS upon checking a state of the power grid while the second step is being performed.

16. A system for electric vehicle charging, the system comprising:
at least one secondary battery capable of charging and discharging;
an input unit receiving power from a power grid in order to charge the secondary battery;
an output unit providing the power to a charger for charging an electric vehicle by discharging the secondary battery; and
a control unit operatively connected to the secondary battery, the input unit, and the output unit and controlling a state of charge (SoC) of the secondary battery when the electric vehicle charging starts and a state of charge (SoC) of the secondary battery when the electric vehicle charging ends to be maintained to be similar to each other,
wherein a charging procedure is performed through the charger by receiving the power of at least one of the power grid and an energy storage system (ESS), and charging of the ESS from the power grid or switching from discharging to charging of the ESS is enabled via control of the control unit during the electric vehicle charging procedure.

17. The system according to claim 16, wherein the control unit provides control for performing:
a first step of comparing a maximum electric energy of the power grid, and a requested electric energy requested for charging the electric vehicle in the charger connected to the ESS including the secondary battery, and the power grid, and charging the electric vehicle by discharging the ESS with respect to power in a range exceeding the maximum electric energy when the requested electric energy is equal to or larger than the maximum electric energy; and
a second step of charging the ESS with power in a range below the maximum electric energy when the requested electric energy is smaller than the maximum electric energy.

18. The system according to claim 16, wherein, in the first step as a high-speed charging interval, the electric vehicle is charged by primarily using the power of the power grid, and the ESS assists the power grid, and in the second step as a low-speed charging interval, the control unit provides the control for performing both the charging and the discharging of the ESS according to a state of the power grid.

19. The system according to claim 16, wherein the input unit, the output unit, and the control unit are provided to implement the ESS with a secondary battery having a capacity smaller than a capacity of a conventional energy storage system (ESS) having a lithium battery.

20. The system according to claim 16, wherein, since changes of charging and discharging outputs of the secondary battery are relatively large according to a state of the power grid, a vanadium ion battery (VIB) capable of handling both a low output and a high output is implemented as the secondary battery.

21. A method for electric vehicle charging for an electric vehicle charging system in which a power grid connected to an energy storage system (ESS) has a maximum electric energy, and a charger connected to the ESS and the power grid has a requested electric energy requested for charging the electric vehicle, the method comprising:
a second step of charging the ESS with power in a range below the maximum electric energy when the requested electric energy is smaller than the maximum electric energy,
wherein a charging procedure is performed through the charger by receiving the power of at least one of the power grid and the ESS, and charging of the ESS from the power grid or switching from discharging to charging of the ESS is enabled during the electric vehicle charging procedure.

22. The method according to claim 21, further comprising:
a first step of charging the electric vehicle by discharging the ESS for a power which is in a range of exceeding the maximum electric energy when the requested electric energy is equal to or larger than the maximum electric energy.
